(19) United States
(12) Patent Application Publication
(10) Pub. No.: US 2025/0209443 A1
(43) Pub. Date: Jun. 26, 2025

(54) SYSTEMS AND TECHNIQUES FOR MAINTAINING A SYSTEM OF RECORD

(71) Applicant: Capital One Services, LLC, McLean, VA (US)

(72) Inventors: Casey Scott Barrett, McLean, VA (US); Wayne Lutz, McLean, VA (US); Kevin Osborn, McLean, VA (US); David Ross, McLean, VA (US)

(73) Assignee: Capital One Services, LLC, McLean, VA (US)

(21) Appl. No.: 18/972,087

(22) Filed: Dec. 6, 2024

Related U.S. Application Data
(60) Provisional application No. 63/606,992, filed on Dec. 6, 2023.

(51) Int. Cl. G06Q 20/34; H04L 9/08

(52) U.S. Cl. CPC G06Q 20/355; H04L 9/0866; H04L 9/0877; H04L 9/0897

(57) ABSTRACT

Described herein are techniques a systems for maintaining a system of record for one or more contactless cards. A computing apparatus is configured to generate a first unique identifier for a contactless card associated with a user account. The apparatus is further caused to generate a message to update a database with a new database entry, the message including the first unique identifier and identity information for the user account. Next, the apparatus is caused to send the message to the database to add the new entry therein, each entry in the database including a recorded unique identifier associated with a corresponding contactless card, each contactless card being associated with one of a plurality of user accounts. The apparatus is further caused to send the first unique identifier to a personalization server to store the first unique identifier in a memory of the first contactless card.

### RELATED APPLICATIONS

The present application claims priority to U.S. Provisional Patent Application Ser. No. 63/606,992 entitled “SYSTEMS AND TECHNIQUES TO PERFORM CARD FUNCTIONS IN A COMPUTER ENVIRONMENT,” filed on Dec. 6, 2024, the contents of which are incorporated herein in its entirety.

### BACKGROUND

Contactless card products have become so universally well-known and ubiquitous that they have fundamentally changed the manner in which security verifications, transactions, and dealings are viewed and conducted in society today. Contactless card products are most commonly represented by plastic or metal card-like members that are offered and provided to customers through card issuers (such as banks, financial institutions, gyms, apartment complexes, workplaces, and the like). With a card, an authorized cardholder is able to perform various functions that ordinarily would require an exchange of physical property, verification of an identification card, remembering or entering a password, or other requirements. Data security and transaction integrity are of critical importance to businesses facilitating these transactions and to the cardholders. This need continues to grow as functions performed with contactless cards constitute an increasingly large share of commercial and other daily activity.

Accordingly, there is a need to provide organizations and cardholders with an appropriate solution that overcomes current deficiencies to provide data security, authentication, and verification for contactless cards.

### SUMMARY

In one aspect, a method for maintaining a system of record is disclosed. In some embodiments, the method includes receiving a request to issue a first contactless card to be associated with a user account. The method further includes generating a first unique identifier for the contactless card, the first unique identifier being separate from a primary account number for the contactless card. The method further includes maintaining a system of record including one or more entries in a first database, each of the one or more entries including a recorded unique identifier associated with a corresponding contactless card and an issuer identifier of an issuer of the contactless card, each contactless card being associated with one of a plurality of user accounts. The method further includes updating the system of record with a new entry, including the first unique identifier for the first contactless card and the issuer identifier of the issuer of the contactless card, the new entry being assigned to the user account from which the request was received. The method further includes sending the first unique identifier to a personalization server, where the personalization server is configured to store the first unique identifier in a memory of the first contactless card during personalization of the first contactless card.

In another aspect, a computing apparatus is provided that includes a processor and a memory storing instructions that, when executed by the processor, cause the computing apparatus to perform various operations. In some embodiments, the processor is caused to generate a first unique identifier for a contactless card associated with a user account, the first unique identifier being separate from a primary account number for the contactless card. In some embodiments, the processor is caused to generate a message to update a database with a new database entry, the message including the first unique identifier for the first contactless card and identity information for the user account. In some embodiments, the processor is caused to send the message to the database to add the new entry therein, the database configured to make one or more entries, each of the one or more entries including a recorded unique identifier associated with a corresponding contactless card, each contactless card being associated with one of a plurality of user account. In some embodiments, the processor is caused to send the first unique identifier to a personalization server, where the personalization server is configured to store the first unique identifier in a memory of the first contactless card during personalization of the first contactless card.

In another aspect, a non-transitory computer-readable storage medium is disclosed, the computer-readable storage medium including instructions that when executed by a processor, cause the processor to perform various operations. For example, in some embodiments, the processor is caused to receive a request to personalize a first contactless card to be associated with a user account, where personalization includes initialization of the contactless card. In some embodiments, the processor is caused to generate personalization data for the contactless card, the personalization data including at least a first unique identifier for the contactless card, where the first unique identifier is separate from a primary account number of the contactless card. In some embodiments, the processor is caused to populate a database entry in a database with the first unique identifier, the database entry being assigned to the user account, and the database entry including an issuer identifier of an issuer of the contactless card, and send the personalization data to a personalization server, where the personalization server is configured to store the personalization data in a memory of the first contactless card during personalization of the first contactless card.

Non-transitory computer program products (e.g., physically embodied computer program products) are also described that store instructions, which, when executed by one or more data processors (e.g., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 illustrates an example system flow diagram in accordance with one embodiment.

FIG. 2 illustrates a database environment in accordance with one embodiment.

FIG. 3 illustrates example table entries in accordance with one embodiment.

FIG. 4 illustrates a contactless card in accordance with one embodiment.

FIG. 5 illustrates a transaction card component in accordance with one embodiment.

FIG. 6 illustrates a flow diagram of an example method in accordance with one embodiment.

FIG. 7 illustrates a message format in accordance with one embodiment.

### DETAILED DESCRIPTION

Disclosed herein are systems and techniques for maintaining a system of record, specifically in the context of contactless cards and the like. The techniques described herein may begin when a request for a new contactless card is received and the personalization process begins. A contactless card is assigned one or more unique identifiers, including a primary account number and a personalization unique identifier (pUID). The pUID is added to a database along with another card identifier that is unique to the card, an issuer identifier of the issuer that is issuing (or personalizing) the card, and an account identifier that is unique to the account that the card is associated with. For example, a cardholder may have an account number with an institution, and the cardholder may have more than one contactless card with the institution and assigned to or associated with the account number. The database may also include a fraud state of the contactless card and the expiration date of the contactless card. This database is filled with one or more contactless card entries as new contactless cards are issued or personalized.

Moreover, the pUID and the primary account number are installed in the memory of the contactless card during the personalization process. The personalization process of the contactless card is the process of encoding data to the contactless card's processor, memory device, and/or magnetic stripe when the contactless card is first issued by the institution issuing the contactless card. This process may involve writing the pUID, primary account number, encryption keys, or other personalization data to a write once, read many memory sections on the contactless card. The act of writing the pUID and other data once to the contactless card prevents the important data distinguishing issued cards from other contactless cards from being altered, thereby improving security features of the card.

The systems and techniques described herein present an improvement to computer related technology by improving security and interoperability of contactless cards. Including the pUID and encryption information on the memory of the contactless card itself will allow more complex security measures to be implemented by the contactless card, thereby creating more secure transactions and other functions performed by the contactless cards. Moreover, embodiments described herein cannot practically be performed by a human alone without using a particular machine or device, such as computers specifically designed to communicate with memory devices in contactless cards.

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The systems discussed here may enable users to perform these functions in a multi-issuer environment. Further, the systems discussed herein enable card issuers or payment providers, such as banks, to issue contactless cards with tap-to functions to customers while maintaining high-level security. The systems and techniques discussed differ from previous solutions because they provide a single platform for multiple issuers to provide the tap-to functionality.

Further, contactless card embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

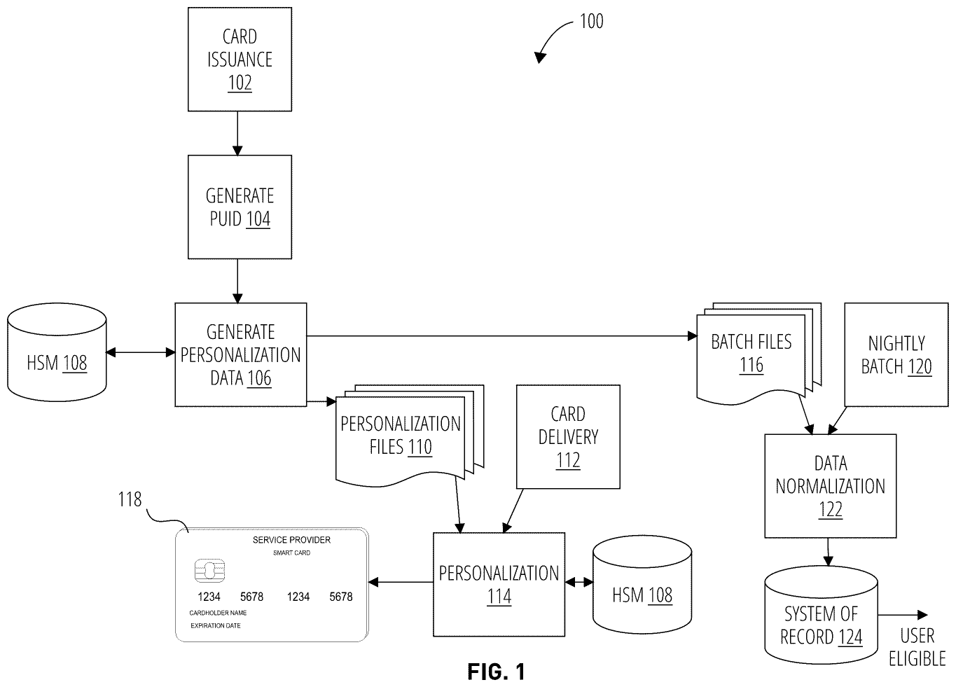

FIG. 1 illustrates an example system flow diagram 100 of the system according to some embodiments of the present disclosure. Some aspects of the system can be implemented using one or more servers, such as an issuer server operated by the issuer of the contactless card, a personalization server used to personalize (as defined above) contactless cards, and a server configured to maintain a system of record or a database as described herein. Each of the issuer server, personalization server, and server for maintaining the system of record can be all the same server, all different servers, or a combination of servers. The functionality of these servers is more relevant and is described herein.

First, the issuer receives a request for a new contactless card, such as contactless card 118. The request may be, for example, from a new contactless card application completed by a customer of a bank, workplace, gym facility, apartment complex, or any other suitable organization. The request may come from a mobile application operating on a user's mobile device, or from a website or web application.

The contactless card may be a credit card, debit card, identification card, security card, facility or location entry card, or any other suitable contactless card. The request for the new contactless card may come in a batch of one or more requests for a new contactless card. Once the request is received, the system flow diagram 100 moves to card issuance 102, which involves a server such as the issuer server (not shown) initiating issuance of the contactless card 118, including initiation of personalization of the contactless card 118. This may also involve instructing issuance of a plurality of contactless cards in response to a batch of card requests received.

Next, the system flow diagram 100 moves to generate pUID 104, which involves generating a unique personalization unique identifier (pUID) for the contactless card being issued. In embodiments where a batch of cards are being issued, a unique pUID is generated for each contactless card being issued. In some embodiments, the pUID may be a string of binary coded decimal numbers. For example, in some embodiments, the pUID may be a 16-byte string of numbers between 0 and 9. In some other embodiments, the pUID includes any number of suitable characters. In other embodiments, the pUID is a base-ten number or comprises other alphanumeric characters.

In some embodiments, once the pUID is generated, the system flow diagram 100 moves to generate personalization data 106 wherein personalization data for the card is generated. In some embodiments, the personalization data includes a primary account number for the contactless card, a card identifier (cardID) that is separate from the primary account number, a card expiration date, and a card verification value (CVV). The cardID is used as a unique identifier for the card itself and is tied to primary account. Moreover, the personalization server that generates the personalization data communicates with a hardware security module (HSM) 108 to generate encrypted user keys that are included in the personalization data. The encrypted user keys include a private and public key pair used for key encryption for encrypting data and communications sent from the contactless card to various devices and entities.

Once the personalization data is generated, it is stored in personalization files 110. Card delivery 112 information and the personalization data stored in the personalization files 110 are then sent to a personalization 114 module for personalizing the contactless card 118. The personalization process includes encoding data to the contactless card's processor, memory device, and/or magnetic stripe when the contactless card 118 is first issued by the institution issuing the contactless card. This process may involve writing the pUID, primary account number, encryption keys, or other personalization data to a write once, read many memory section on the contactless card 118. The act of writing the pUID and other data once to the contactless card 118 prevents the important data distinguishing issued cards from other contactless cards from being altered, thereby improving security features of the card. Before the contactless card 118 is personalized, the HSM 108 is again communicated with to encrypt the personalization data with a session key. Then the encrypted personalization data is stored in memory on the contactless card 118 during the personalization process.

The personalization data, including the pUID, a card type of the contactless card 118, the card identifier, the issuer ID, the expiration date, and cardholder identification information are also stored in batch files 116 for storing in a system of record 124. Once the personalization data, card data, and cardholder information are stored in the batch files and the data is prepared for storing in the system of record 124, a nightly batch 120 of cards that were personalized, including the batch files of the newly personalized card are subject to data normalization 122. During data normalization 122, the server would consider which issuer the contactless card 118 is being issued by and send the pUID along with the primary account number associated with the pUID to the issuer. Data normalization may also include mapping data fields of one database to another database schema. For example, in some embodiments, one issuer may provide data fields for entry into the system of record 124 using one schema, and the data may need to be mapped such that the data fields can be entered into the system of record 124 using the database schema of the system of record 124.

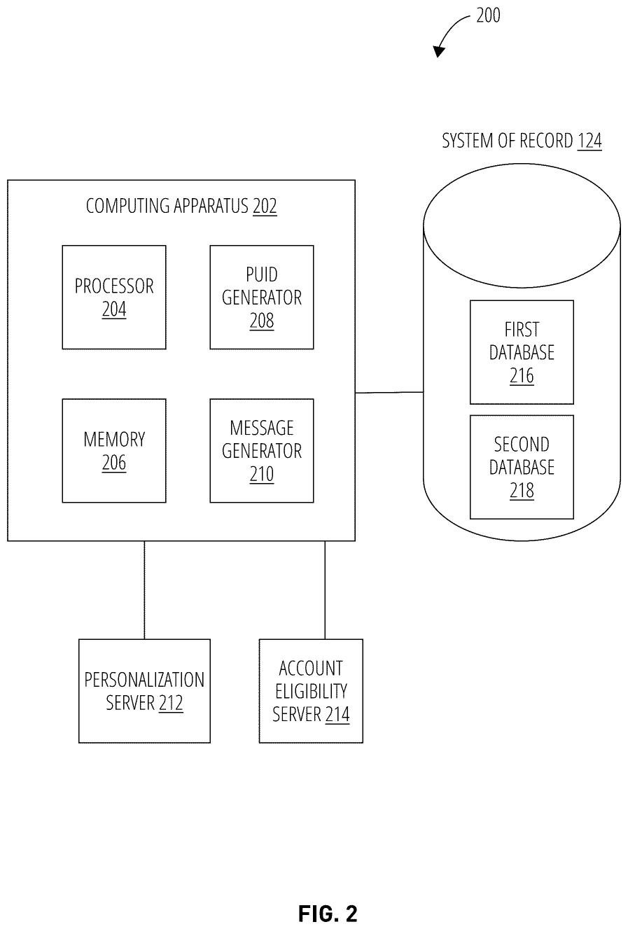

Next, the system of record 124 is updated with the pUID and account information of the contactless card 118. The cardID is used as an index for the contactless card 118 in the system of record 124. That is, the system of record includes at least one entry of a contactless card 118, referenced by the cardID associated with the contactless card 118. The system of record 124 may include at least two different databases, an accounts table/database and a cards table/database. The accounts table is a database with one entry per account, each account assigned to a cardholder account, and each account associated with one or more contactless cards. The cards table is a database with one entry per contactless card issued. Each contactless card is associated with a corresponding account in the accounts table. The account may be indicated in the cards database and the accounts database by the primary account number or some other account identifier associated with the cardholder. Before the card is personalized, the system may send a request to an account eligibility server, such as account eligibility server 214 shown in FIG. 2. to determine whether the user account is eligible to receive issuance of the contactless card 118. The system may proceed with generating the first unique identifier for the contactless card and with issuing the contactless card 118 in response to a reply from the account eligibility server indicating that the user account is eligible to receive issuance of the contactless card 118.

FIG. 2 illustrates a database environment 200 including a computing apparatus 202, personalization server 212, account eligibility server 214, and a system of record 124 as described above. The database environment 200 includes a network of computing devices that communicate over a wired or wireless network to maintain the system of record 124. The computing apparatus 202 is configured to communicate with the personalization server 212, account eligibility server 214, and system of record 124 over the network (not shown).

In some embodiments, the database environment 200 includes a computing apparatus 202 comprising a processor 204 and a memory 206 storing instructions that, when executed by the processor 204, cause the computing apparatus 202 to perform various operations. In some embodiments, the computing apparatus 202 can include a server computer (e.g., the personalization server 212), a personal computer, a cloud server, a data center server, or any other suitable computing apparatus or device.

In some embodiments, the processor 204, after executing the instructions, is caused to generate a first unique identifier for a contactless card associated with a user account, the first unique identifier being separate from a primary account number for the contactless card. In some embodiments, the first unique identifier can be the pUID described herein. As described above, in some embodiments, the first unique identifier is a string of binary coded decimal (BCD) numbers or characters. In some other embodiments, the string of BCD numbers or characters of the first unique identifier is a 16-byte string of BCD numbers or characters. In some other embodiments, the first unique identifier includes any number of suitable BCD numbers or characters. In other embodiments, the first unique identifier is a string of base-ten characters or other alphanumeric characters. To create the first unique identifier, the processor 204 engages with a PUID generator 208 of the computing apparatus 202.

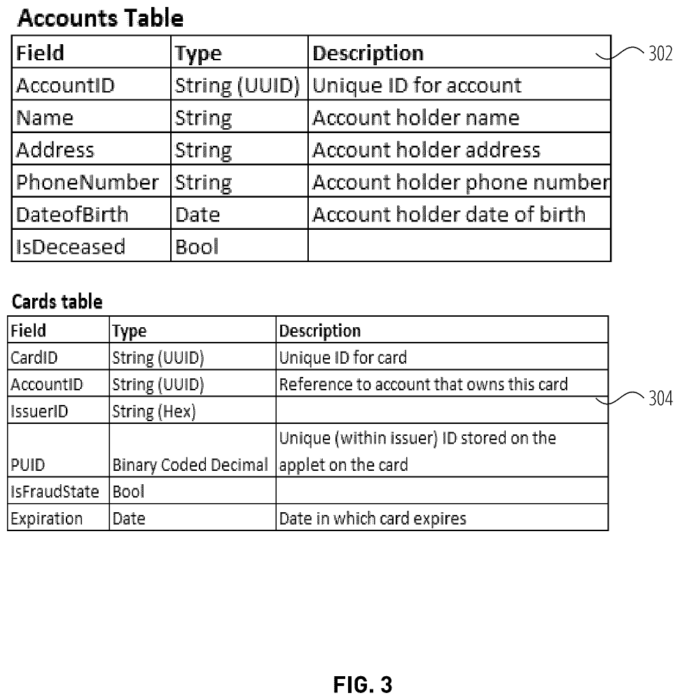

In some embodiments, the processor 204 is further caused to engage with message generator 210 to generate a message to update a database with a new database entry, the message including the first unique identifier for the first contactless card and identity information for the user account. For example, the processor 204 can be caused to send the message to the system of record 124 to update an entry in the first database 216 or the second database 218. The first database 216 can maintain an accounts database and second database 218 can maintain a cards database or a database of issued or personalized contactless cards. In the first database 216, the accounts database includes one or more entries for each unique account associated with a user or cardholder. The cardholder may have at least one account with one or more contactless cards associated therewith. FIG. 3 provides more detail on what each database entry may include for the first database 216 and the second database 218.

In some embodiments, the processor 204 is caused to send the message to the database (e.g., the system of record 124) to add the new entry therein (e.g., a new entry to the first second database 218), the database configured to make one or more entries, each of the one or more entries including a recorded unique identifier (e.g., a pUID) associated with a corresponding contactless card, each contactless card being associated with one of a plurality of user accounts.

In some embodiments, execution of the instructions further cause the processor 204 to send a request to a hardware security module (HSM), such as HSM 108, to generate the one or more encrypted keys. The processor 204 then receives a reply from the HSM that includes the one or more encrypted keys.

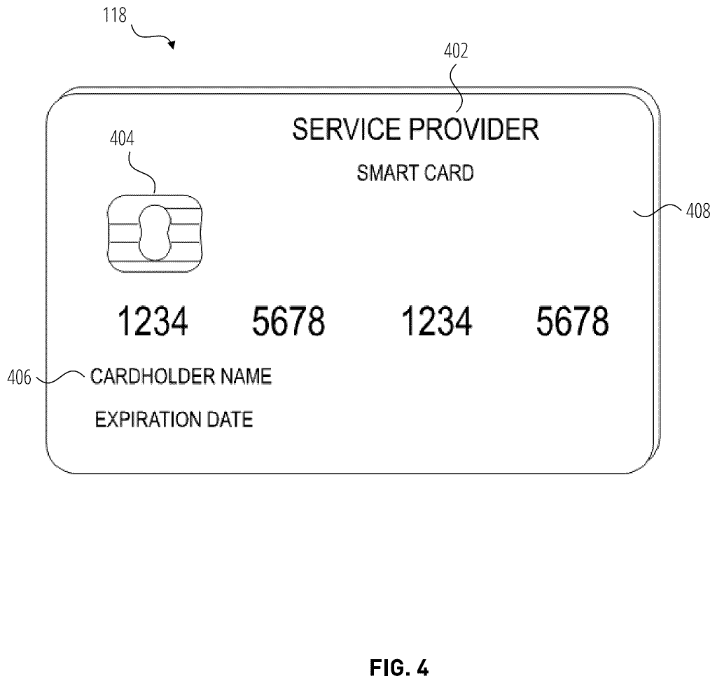

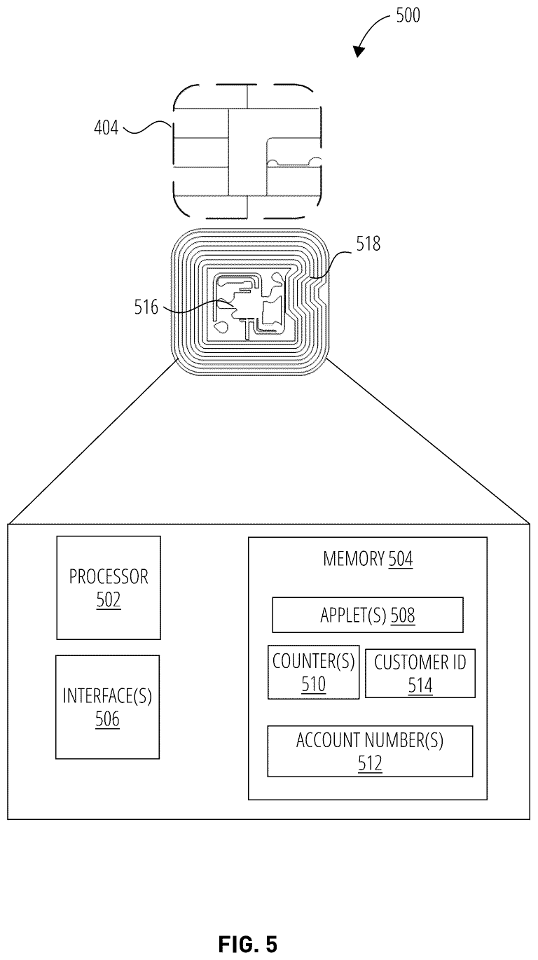

In some embodiments, the processor 204 is caused to generate personalization data for a personalization server 212, the personalization data including at least the primary account number, an issuer identifier, and the one or more encrypted keys as described herein. The issuer identifier is a unique identifier of the issuer of the contactless card. The processor 204 is further caused to send the personalization data and the first unique identifier (e.g., the pUID) to the personalization server 212 for the personalization server 212 to store the personalization data and the first unique identifier in a memory of the first contactless card. For example, the personalization server 212 can store the personalization data, including the pUID, in the memory 504 of the contactless card 118 illustrated in FIG. 4 and FIG. 5.

In some embodiments, the personalization data, including the primary account number, issuer identifier, and first unique identifier are encrypted using the one or more encrypted keys before being sent to the memory for storage thereon. In some embodiments, the instructions further cause the computing apparatus to send a request to an account eligibility server 214 to determine whether the user account that requested issuance of the first contactless card is eligible to receive issuance of the first contactless card. In some embodiments, the processor 204 is further caused to generate the first unique identifier for the contactless card and issue the first contactless card in response to a reply from the account eligibility server 214 indicating that the user account is eligible to receive issuance of the first contactless card.

FIG. 3 illustrates example database entries in the first database 216 and second database 218 described above. For example, accounts database entry 302 shows an example entry in the first database 216 described above. Moreover, cards database entry 304 shows an example entry in the second database 218 described above. The first database 216 includes an entry for each user account having at least one personalized contactless card, wherein each entry for each user account includes at least the user account identifier, account holder contact information (e.g., name, address, phone number, etc.), a date of birth of the account holder, and an indication of whether the account holder is deceased. Moreover, in the second database 218, each entry includes at least the unique identifier (e.g., pUID), a user account identifier, an issuer identifier, a fraud state, and an expiration date of a corresponding contactless card wherein the second database 218 includes an entry for each contactless card that has been personalized. Each entry in the second database 218 further includes a separate card identifier that is also a unique ID for the contactless card.

One or more of these entries can be maintained in the system of record 124 described above. In this way, the pUID of a given contactless card can be associated with an account ID or account number associated with the user or cardholder. Each cardholder can have a single account number that has multiple pUIDs and corresponding contactless cards associated therewith or assigned thereto.

FIG. 4 illustrates an example configuration of a contactless card 118 from the above description, which may include a contactless card, a payment card, such as a credit card, debit card, or gift card, issued by a service provider as displayed as service provider indicia 402 on the front or back of the contactless card 118. In some examples, the contactless card 118 is not related to a payment card, and may include, without limitation, an identification card, a card to permit entry into a facility such as a gym, apartment, hotel, etc. In some examples, the transaction card may include a dual interface contactless payment card, a rewards card, and so forth. The contactless card 118 may include a substrate 408, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 118 may have physical characteristics compliant with the ID-1 format of the ISO/IEC 7816 standard, and the transaction card may otherwise be compliant with the ISO/IEC 14443 standard. However, it is understood that the contactless card 118 according to the present disclosure may have different characteristics, and the present disclosure does not require a transaction card to be implemented in a payment card.

The contactless card 118 may also include identification information 406 displayed on the front and/or back of the card, and a contact pad 404. The contact pad 404 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 118 may also include processing circuitry, antenna and other components as will be further discussed in FIG. 5. These components may be located behind the contact pad 404 or elsewhere on the substrate 408, e.g. within a different layer of the substrate 408, and may electrically and physically coupled with the contact pad 404. The contactless card 118 may also include a magnetic strip or tape, which may be located on the back of the card (not shown in FIG. 4). The contactless card 118 may also include a Near-Field Communication (NFC) device coupled with an antenna capable of communicating via the NFC protocol. Embodiments are not limited in this manner.

As illustrated in FIG. 4, the contact pad 404 of contactless card 118 may include processing circuitry 516 for storing, processing, and communicating information, including a processor 502, a memory 504, and one or more interface(s) 506. It is understood that the processing circuitry 516 may contain additional components, including processors, memories, error and parity/CRC checkers, data encoders, anticollision algorithms, controllers, command decoders, security primitives and tamperproofing hardware, as necessary to perform the functions described herein.

The memory 504 may be a read-only memory, write-once read-multiple memory or read/write memory, e.g., RAM, ROM, and EEPROM, and the contactless card 118 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 504 may be encrypted memory utilizing an encryption algorithm executed by the processor 502 to encrypted data.

The memory 504 may be configured to store one or more applet(s) 508, one or more counter(s) 510, a customer identifier 514, and the account number(s) 512, which may be virtual account numbers. The one or more applet(s) 508 may comprise one or more software applications configured to execute on one or more contactless cards, such as a Java® Card applet. However, it is understood that applet(s) 508 are not limited to Java Card applets, and instead may be any software application operable on contactless cards or other devices having limited memory. The one or more counter(s) 510 may comprise a numeric counter sufficient to store an integer. The customer identifier 514 may comprise a unique alphanumeric identifier assigned to a user of the contactless card 118, and the identifier may distinguish the user of the contactless card from other contactless card users. In some examples, the customer identifier 514 may identify both a customer and an account assigned to that customer and may further identify the contactless card 118 associated with the customer's account. As stated, the account number(s) 512 may include thousands of one-time use virtual account numbers associated with the contactless card 118. An applet(s) 508 of the contactless card 118 may be configured to manage the account number(s) 512 (e.g., to select an account number(s) 512, mark the selected account number(s) 512 as used, and transmit the account number(s) 512 to a mobile device for autofilling by an autofilling service.

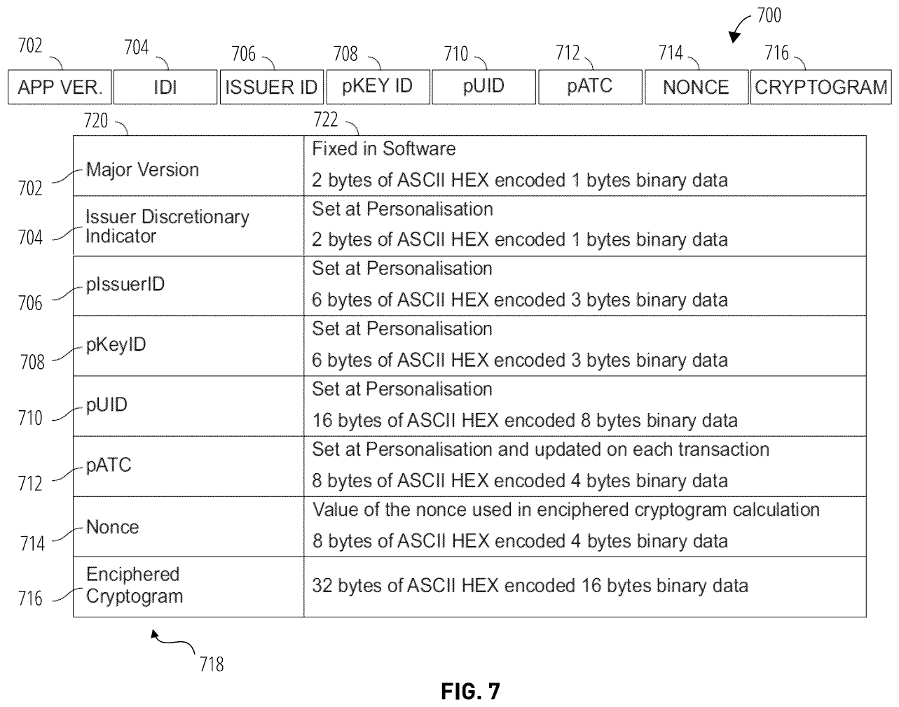

In some embodiments, the memory 504 can include (e.g., have stored therein) the data from the fields shown in FIG. 5 and/or FIG. 7. The processor 502 can then use the data from the fields to generate the message 700 as described above.

The processor 502 and memory elements of the foregoing exemplary embodiments are described with reference to the contact pad 404, but the present disclosure is not limited thereto. It is understood that these elements may be implemented outside of the contact pad 404 or entirely separate from it, or as further elements in addition to processor 502 and memory 504 elements located within the contact pad 404.

In some examples, the contactless card 118 may comprise one or more antenna(s) 518. The one or more antenna(s) 518 may be placed within the contactless card 118 and around the processing circuitry 516 of the contact pad 404. For example, the one or more antenna(s) 518 may be integral with the processing circuitry 516 and the one or more antenna(s) 518 may be used with an external booster coil. As another example, the one or more antenna(s) 518 may be external to the contact pad 404 and the processing circuitry 516.

In an embodiment, the coil of contactless card 118 may act as the secondary of an air core transformer. The terminal may communicate with the contactless card 118 by cutting power or amplitude modulation. The contactless card 118 may infer the data transmitted from the terminal using the gaps in the contactless card's power connection, which may be functionally maintained through one or more capacitors. The contactless card 118 may communicate back by switching a load on the contactless card's coil or load modulation. Load modulation may be detected in the terminal's coil through interference. More generally, using the antenna(s) 518, processor 502, and/or the memory 504, the contactless card 118 provides a communications interface to communicate via NFC, Bluetooth, and/or Wi-Fi communications.

As explained above, contactless card 118 may be built on a software platform operable on smart cards or other devices having limited memory, such as JavaCard, and one or more or more applications or applets may be securely executed. Applet(s) 508 may be added to contactless cards to provide a one-time password (OTP) for multifactor authentication (MFA) in various mobile application-based use cases. Applet(s) 508 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 508 may be configured to encode the OTP as an NDEF type 4 well known type text tag. In some examples, NDEF messages may comprise one or more records. The applet(s) 508 may be configured to add one or more static tag records in addition to the OTP record.

In some examples, the one or more applet(s) 508 may be configured to emulate an RFID tag. The RFID tag may include one or more polymorphic tags. In some examples, each time the tag is read, different cryptographic data is presented that may indicate the authenticity of the contactless card. Based on the one or more applet(s) 508, an NFC read of the tag may be processed, the data may be transmitted to a server, such as a server of a banking system, and the data may be validated at the server.

In some examples, the contactless card 118 and server may include certain data such that the card may be properly identified. The contactless card 118 may include one or more unique identifiers (not pictured). Each time a read operation takes place, the counter(s) 510 may be configured to increment. In some examples, each time data from the contactless card 118 is read (e.g., by a mobile device), the counter(s) 510 is transmitted to the server for validation and determines whether the counter(s) 510 are equal (as part of the validation) to a counter of the server.

The one or more counter(s) 510 may be configured to prevent a replay attack. For example, if a cryptogram has been obtained and replayed, that cryptogram is immediately rejected if the counter(s) 510 has been read or used or otherwise passed over. If the counter(s) 510 has not been used, it may be replayed. In some examples, the counter that is incremented on the card is different from the counter that is incremented for transactions. The contactless card 118 is unable to determine the application transaction counter(s) 510 since there is no communication between applet(s) 508 on the contactless card 118.

In some examples, the counter(s) 510 may get out of sync. In some examples, to account for accidental reads that initiate transactions, such as reading at an angle, the counter(s) 510 may increment but the application does not process the counter(s) 510. In some examples, when a mobile device is woken up, NFC may be enabled and the mobile device may be configured to read available tags, but no action is taken responsive to the reads.

To keep the counter(s) 510 in sync, an application, such as a background application, may be executed that would be configured to detect when the mobile device wakes up and synchronize with the server of a banking system indicating that a read that occurred due to detection to then move the counter(s) 510 forward. In other examples, Hashed One Time Password may be utilized such that a window of mis-synchronization may be accepted. For example, if within a threshold of 10, the counter(s) 510 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 510 increases in the appropriate sequence, then it possible to know that the user has done so.

The key diversification technique described herein with reference to the counter(s) 510, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 118, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 118. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 118 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

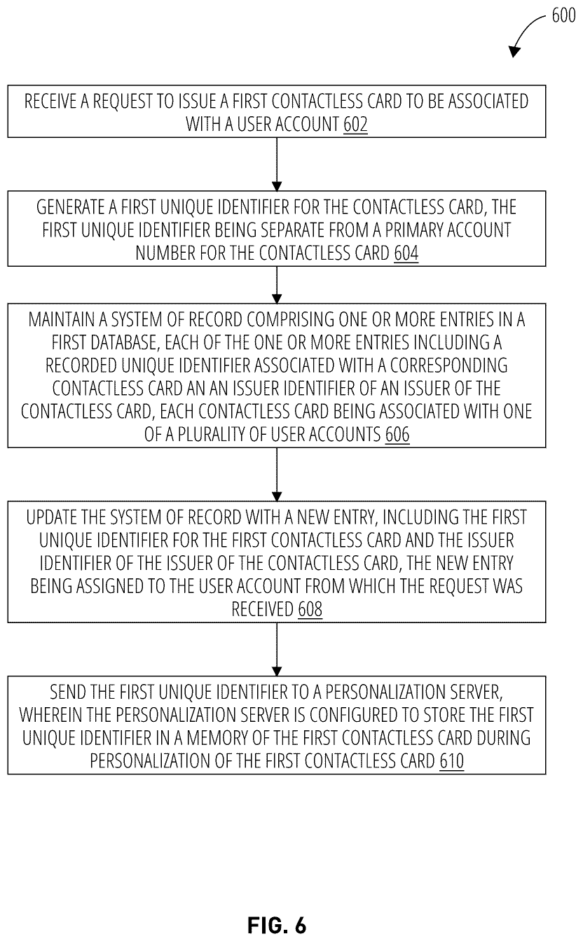

FIG. 6 illustrates an example method for maintaining a system of record according to some embodiments of the present disclosure. As shown at block 602, the method 600 includes receiving a request to issue a first contactless card to be associated with a user account. As shown at block 604, the method 600 includes generating a first unique identifier for the contactless card, the first unique identifier being separate from a primary account number for the contactless card. As shown at block 606, the method 600 includes maintaining a system of record comprising one or more entries in a first database, each of the one or more entries including a recorded unique identifier associated with a corresponding contactless card an an issuer identifier of an issuer of the contactless card, each contactless card being associated with one of a plurality of user accounts. As shown at block 608, the method 600 includes updating the system of record with a new entry, including the first unique identifier for the first contactless card and the issuer identifier of the issuer of the contactless card, the new entry being assigned to the user account from which the request was received. As shown at block 610, the method 600 includes sending the first unique identifier to a personalization server, wherein the personalization server is configured to store the first unique identifier in a memory of the first contactless card during personalization of the first contactless card.

In some embodiments, the method 600 further includes generating personalization data for the personalization server, the personalization data including at least an account identifier and one or more encrypted keys; and sending the personalization data to the personalization server for the personalization server to store the personalization data in the memory of the first contactless card.

In some embodiments, the method 600 further comprises sending a request to a hardware security module (HSM) to generate the one or more encrypted keys; and receiving a reply from the HSM that includes the one or more encrypted keys.

In some embodiments of the method 600, the account identifier, issuer identifier, and unique identifier are encrypted with the one or more encrypted keys before being sent to the memory for storage thereon. In some embodiments of the method 600, the first unique identifier is a string of binary coded decimal numbers. In some embodiments, the method 600 further comprises in response to receiving the request to issue the first contactless card, sending a request to an account eligibility server to determine whether the user account is eligible to receive issuance of the first contactless card; and proceeding with generating the first unique identifier for the contactless card and issuing the first contactless card in response to a reply from the account eligibility server indicating that the user account is eligible to receive issuance of the first contactless card.

In some embodiments of the method 600, the system of record includes the first database and a second database, wherein the first database maintains a list of contactless cards that have been personalized and the second database maintains a list of user accounts; the first database includes an entry for each contactless card that has been personalized, each entry including at least the unique identifier, a user account identifier, an issuer identifier, a fraud state, and an expiration date of a corresponding contactless card; and the second database includes an entry for each user account having at least one personalized contactless card, wherein each entry for each user account includes at least the user account identifier, account holder contact information, a date of birth of the account holder, and an indication of whether the account holder of a corresponding user account is deceased.

FIG. 7 illustrates an example of a message 700 that may be communicated by a contactless card, such contactless card 118 personalized using the techniques described herein, to perform various functions, including validation of a transaction, gaining entry to a secure location (e.g., hotel room, gym, security location, school, workplace, etc.), activating a controller to unlock a locker, etc. The message can be sent as part of a near field communication (NFC) read of the 118. All of the message 700, or any part thereof, may be decrypted using an encryption key, such as a key generated by the HSM 108.

In embodiments, the message 700 includes an applet version 702 field, an issuer discretionary indicator 704 field, an Issuer Identifier 706 field, a pKey ID 708 field, a pUID 710 field, a pATC 712 field, a nonce 714 field, and an encrypted cryptogram 716.

In embodiments, the fields may be in plain text or encrypted. For example, the applet version 702 field may include an applet version in plain text. The applet version indicates which applet version is installed on a contactless card and may be used by the other systems to determine how to process the message 700 when communicated. For example, different Applet versions require different validation logic, e.g., an older message may be routed through the issuer system to perform various operations for validation, while a newer message may be routed through the switchboard system to perform the various operations, including validation.

In embodiments, the message 700 includes an issuer discretionary indicator 704 field that may include issuer data and set at the time of personalization. In addition, the message 700 includes an Issuer Identifier 706 field that may include a unique ID assigned to the entity issuing the card, e.g., the issuer. For example, when joining the system, each issuer may be assigned a unique identifier during an onboarding operation. The issuer ID can be used by the switchboard system 708 to route a message and its contents to the appropriate services that are associated with that particular issuer.

In embodiments, the message 700 includes a pKey ID 708 field. In some instances, the pKey ID 708 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 118 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 700 may include a pUID 710 field, including a card unique identifier assigned to the contactless card at personalization time. The pUID 710 field data may be a combination of alphanumeric characters used to identify each card and associated with a user uniquely.

In embodiments, the message 700 includes a pATC 712 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 700 is created, a new session key is derived and utilized to generate one or more portions of the message 700. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 700 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 118 may communicate a message between a device, such as a mobile device, during a read operation. For example, in response to the contactless card 118 being tapped onto a surface of the device, e.g., brought within wireless communication range, a read operation may be performed on the contactless card 118, and the contactless card 118 may generate and provide the message to the device. For example, once within range, the contactless card 118 and the device may perform one or more exchanges for the contactless card 118 to send the message to the device.

The wireless communication may be in accordance with a wireless protocol, such as near-field communication (NFC), Bluetooth, WiFi, and the like. In some instances, a message may be communicated between a contactless card 118 and a device via wired means, e.g., via the contact pad, and in accordance with the EMV protocol.

As discussed above, the contactless card 118 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 118. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 118 stores the generated application key(s) or UDK(s).

In embodiments, the contactless card 118 utilizes the application key(s) or UDK(s) to generate session keys for each encrypted data is generated. The following is one processing flow that may be performed by the contactless to generate a unique cryptogram session key (ASK).

To generate the ASK, the contactless card 118 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 118 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 118 concatenates SKL with SKR to form an authentication session key (ASK). In embodiments, the ASK is used to perform operations utilizing the contactless card 118, such as encrypting the cryptographic MAC.

In embodiments, the contactless card 118 also supports session key derivation to generate a unique encipherment session key DESK. The contactless card 118 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 118 computes SKR by encrypting [ATC[2]∥ATC[3]∥‘0F’∥‘00’∥‘00∥‘00’∥‘00’∥‘00’] with the DEK or UDK. The contactless card 118 concatenates SKL with SKR to form the Data Encipherment Session Key (DESK).

In embodiments, the contactless card 118 generates encrypted data or a cryptogram utilizing the session keys. Specifically, the contactless card 118 generates a cryptogram C by calculating a MAC over the 32-byte transaction data T using the Authentication Session Key (ASK).

The contactless card 118 may process the data to generate the cryptogram. Specifically, the contactless card 118 divides T into four blocks of 8 bytes of data: T=T1∥T2∥T3∥T4. The contactless card 118 computes B=DES(ASKL) [T1], where is the Data Encryption Standard or another symmetric encryption algorithm, ASKL is a portion of the ASK, e.g., the “left” half of the key. The contactless card 118 computes B=[B XOR T2], and, the contactless card 118 computes B=DES(ASKL) [B], where DES is an encryption algorithm. The contactless card 118 computes B=[B XOR T3], and the contactless card 118 computes B=DES(ASKL) [B]. The contactless card 118 computes B=[B XOR T4], and the contactless card 118 computes B=DES(ASKL) [B]. The contactless card 118 computes B=DES⁻¹(ASKR) [B], where DES⁻¹ is the reciprocal DES operation, and ASKR is a portion of the ASK, e.g., the right half. The contactless card 118 computes the cryptogram C=DES(ASKL)[B].

In embodiments, a contactless card 118 may also encipher the cryptogram to secure the data further. For example, a contactless card 118 may generate an 8-byte random number [RND] and the card computes E1=DES3(DESK) [RND], where DES3 is a symmetric encryption algorithm such as the Triple Data Encryption Standard. The contactless card 118 then computes B=[E1] XOR [C], where C is the cryptogram generated, as discussed above. The contactless card 118 computes E2=DES3(DESK)[B], where B is computed above. Further, the contactless card 118 generates the 16-byte enciphered payload E=[E1]∥[E2].

In embodiments, a device or the contactless card 118 may decrypt the payload E by determining, receiving, or retrieving the payload E. The device computes a RND=DES3⁻¹(DESK)[E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 118 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

The various elements of the devices as previously described with reference to FIGS. 1-7 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving a request to issue a first contactless card to be associated with a user account;
generating a first unique identifier for the contactless card, the first unique identifier being separate from a primary account number for the contactless card;
maintaining a system of record comprising one or more entries in a first database, each of the one or more entries including a recorded unique identifier associated with a corresponding contactless card and an issuer identifier of an issuer of the contactless card, each contactless card being associated with one of a plurality of user accounts;
updating the system of record with a new entry, including the first unique identifier for the first contactless card and the issuer identifier of the issuer of the contactless card, the new entry being assigned to the user account from which the request was received; and
sending the first unique identifier to a personalization server, wherein the personalization server is configured to store the first unique identifier in a memory of the first contactless card during personalization of the first contactless card.

2. The method of claim 1, further comprising:
generating personalization data for the personalization server, the personalization data including at least an account identifier and one or more encrypted keys; and
sending the personalization data to the personalization server for the personalization server to store the personalization data in the memory of the first contactless card.

3. The method of claim 2, further comprising:
sending a request to a hardware security module (HSM) to generate the one or more encrypted keys; and
receiving a reply from the HSM that includes the one or more encrypted keys.

4. The method of claim 2, wherein the account identifier, issuer identifier, and unique identifier are encrypted with the one or more encrypted keys before being sent to the memory for storage thereon.

5. The method of claim 1, wherein the first unique identifier is a string of binary coded decimal numbers.

6. The method of claim 1, further comprising:
sending a request to an account eligibility server to determine whether the user account is eligible to receive issuance of the first contactless card; and
proceeding with generating the first unique identifier for the contactless card and issuing the first contactless card in response to a reply from the account eligibility server indicating that the user account is eligible to receive issuance of the first contactless card.

7. The method of claim 1, wherein the system of record includes the first database and a second database, wherein the first database maintains a list of contactless cards that have been personalized and the second database maintains a list of user accounts;
wherein the first database includes an entry for each contactless card that has been personalized, each entry including at least the unique identifier, a user account identifier, an issuer identifier, a fraud state, and an expiration date of a corresponding contactless card; and
wherein the second database includes an entry for each user account having at least one personalized contactless card, wherein each entry for each user account includes at least the user account identifier, account holder contact information, a date of birth of the account holder, and an indication of whether the account holder of a corresponding user account is deceased.

8. A computing apparatus comprising:
a processor; and
a memory storing instructions that, when executed by the processor, cause the computing apparatus to:
generate a first unique identifier for a contactless card associated with a user account, the first unique identifier being separate from a primary account number for the contactless card;
generate a message to update a database with a new database entry, the message including the first unique identifier for the first contactless card and identity information for the user account;
send the message to the database to add the new entry therein, the database configured to make one or more entries, each of the one or more entries including a recorded unique identifier associated with a corresponding contactless card, each contactless card being associated with one of a plurality of user accounts; and
send the first unique identifier to a personalization server, wherein the personalization server is configured to store the first unique identifier in a memory of the first contactless card during personalization of the first contactless card.

9. The computing apparatus of claim 8, wherein the instructions further cause the computing apparatus to:
generate personalization data for the personalization server, the personalization data including at least the primary account number, an issuer identifier, and one or more encrypted keys; and
send the personalization data and the first unique identifier to the personalization server for the personalization server to store the personalization data and the first unique identifier in the memory of the first contactless card.

10. The computing apparatus of claim 9, wherein the instructions further cause the computing apparatus to:
send a request to a hardware security module (HSM) to generate the one or more encrypted keys; and
receive a reply from the HSM that includes the one or more encrypted keys.

11. The computing apparatus of claim 9, wherein the primary account number, issuer identifier, and first unique identifier are encrypted with the one or more encrypted keys before being sent to the memory for storage thereon.

12. The computing apparatus of claim 8, wherein the first unique identifier is a string of binary coded decimal numbers.

13. The computing apparatus of claim 8, wherein the instructions further cause the computing apparatus to:
send a request to an account eligibility server to determine whether the user account is eligible to receive issuance of the first contactless card; and
generate the first unique identifier for the contactless card and issue the first contactless card in response to a reply from the account eligibility server indicating that the user account is eligible to receive issuance of the first contactless card.

14. The computing apparatus of claim 8, wherein the database includes a first database and a second database, wherein the first database maintains a list of contactless cards that have been personalized and the second database maintains a list of user accounts;
wherein the first database includes an entry for each contactless card that has been personalized, each entry including at least the unique identifier, a user account identifier, an issuer identifier, a fraud state, and an expiration date of a corresponding contactless card; and
wherein the second database includes an entry for each user account having at least one personalized contactless card, wherein each entry for each user account includes at least the user account identifier, account holder contact information, a date of birth of the account holder, and an indication of whether the account holder of a corresponding user account is deceased.

15. A non-transitory computer-readable storage medium, the computer-readable storage medium including instructions that when executed by a processor, cause the processor to:
receive a request to personalize a first contactless card to be associated with a user account, wherein personalization comprises initialization of the contactless card;
generate personalization data for the contactless card, the personalization data including at least a first unique identifier for the contactless card, wherein the first unique identifier is separate from a primary account number of the contactless card;
populate a database entry in a database with the first unique identifier, the database entry being assigned to the user account, and the database entry including an issuer identifier of an issuer of the contactless card; and
send the personalization data to a personalization server, wherein the personalization server is configured to store the personalization data in a memory of the first contactless card during personalization of the first contactless card.

16. The non-transitory computer-readable storage medium of claim 15, wherein the personalization data further includes at least the primary account number, the issuer identifier, and one or more encrypted keys.

17. The non-transitory computer-readable storage medium of claim 16, wherein the instructions further cause the processor to:
send a request to a hardware security module (HSM) to generate the one or more encrypted keys; and
receive a reply from the HSM that includes the one or more encrypted keys.

18. The non-transitory computer-readable storage medium of claim 16, wherein the primary account number, issuer identifier, and unique identifier are encrypted with the one or more encrypted keys before being sent to the memory for storage thereon.

19. The non-transitory computer-readable storage medium of claim 15, wherein the first unique identifier is a string of binary coded decimal numbers.

20. The non-transitory computer-readable storage medium of claim 15, wherein the database includes a first database and a second database, wherein the first database maintains a list of contactless cards that have been personalized and the second database maintains a list of user accounts;
wherein the first database includes an entry for each contactless card that has been personalized, each entry including at least the unique identifier, a user account identifier, an issuer identifier, a fraud state, and an expiration date of a corresponding contactless card; and
wherein the second database includes an entry for each user account having at least one personalized contactless card, wherein each entry for each user account includes at least the user account identifier, account holder contact information, a date of birth of the account holder, and an indication of whether the account holder of a corresponding user account is deceased.
